(19) United States
(12) Patent Application Publication
(10) Pub. No.: US 2026/0017928 A1
(43) Pub. Date: Jan. 15, 2026

(54) LEARNING DEVICE, LEARNING METHOD, AND LEARNING PROGRAM

(71) Applicant: NIPPON TELEGRAPH AND TELEPHONE CORPORATION, Tokyo (JP)

(72) Inventors: Akihiko TAKASHIMA, Musashino-shi, Tokyo (JP); Ryo MASUMURA, Musashino-shi, Tokyo (JP)

(73) Assignee: NIPPON TELEGRAPH AND TELEPHONE CORPORATION, Tokyo (JP)

(21) Appl. No.: 18/994,663

(22) PCT Filed: Jul. 19, 2022
(86) PCT No.: PCT/JP2022/028077

§ 371 Date: Jan. 15, 2025

(51) Int. Cl. G06V 10/77; G06V 10/62; G06V 10/764; G06V 10/776; G06V 10/82; G06V 10/96; G06V 40/16

(52) U.S. Cl. CPC G06V 10/7715; G06V 10/62; G06V 10/764; G06V 10/776; G06V 10/82; G06V 40/176; G06V 10/96

(57) ABSTRACT

A learning device includes processing circuitry configured to extract an encoding feature having a time series direction on a basis of input data of one or both of monomodal data that is data of a single modal or multimodal pair data including a plurality of different modals, embed segment information that is information for identifying a type of the modal of the input data in the encoding feature on a basis of a predetermined condition, connect, on a basis of input condition of a segment-embedded feature in which the segment information is embedded, a plurality of segment-embedded features in the time series direction as a modal-connected feature, and calculate a model parameter using an estimated vector of a cross-modal task estimated on a basis of one or both of the segment-embedded feature or the modal-connected feature and correct data.

### TECHNICAL FIELD

The present invention relates to a learning device, a learning method, and a learning program.

### BACKGROUND ART

As a method of optimizing parameters of each neural network using the neural network and a large number of data in estimation of a cross-modal task, a method of simultaneously inputting pair data of different modals (hereinafter, simply “multimodal pair data”) to the neural network and learning a feature of each modal by the neural network is known (see, for example, Non Patent Literatures 1 and 2). Note that the above-described cross-modal task means a task having an output common to input data of different modals.

Furthermore, the above-described multimodal pair data is, for example, “serial number image data that is image data of a face of a person”, “audio data of a voice of a person”, or the like included in one moving image data having a correct answer label of a certain emotion category in an emotion recognition task (for example, a task of classifying human emotions into categories such as “sorrow” and “happiness”). Then, in a case of performing the emotion recognition task in the estimation of the cross-modal task of the existing technique, there is a case of using moving image data including the multimodal pair data as learning data or inference input data.

### CITATION LIST

### Non Patent Literature

Non Patent Literature 1: Valentin Vielzeuf and Stephane Pateux and Frederic Jurie: Temporal multimodal fusion for video emotion classification in the wild, In Proc. ACM International Conference on Multimodal Interaction (ICMI), P. 569-57, 2017
Non Patent Literature 2: Panagiotis Tzirakis and George Trigeorgis and Mihalis A. Nicolaou and Bjorn W. Schuller and Stefanos Zafeiriou: End-to-End Multimodal Emotion Recognition Using Deep Neural Networks, IEEE JOURNAL OF SELECTED TOPICS IN SIGNAL PROCESSING Vol. 11, Number. 8, P. 1301-1309, 2017

### SUMMARY OF INVENTION

### Technical Problem

However, in the existing technique, in the estimation of the cross-modal task, accuracy is deteriorated in a case where a large amount of multimodal pair data cannot be prepared, and there is a case where a task cannot be estimated from data of one modal in a case where there is a modal defect.

For example, in the estimation of the cross-modal task in the existing technique, a method of simultaneously inputting the multimodal pair data to the neural network is adopted, and an estimation device operates only in a case where the multimodal pair data is simultaneously input. Therefore, there is a problem that data of a single modal (hereinafter, simply “monomodal data”) cannot be utilized.

Meanwhile, in learning in a neural network, parameter estimation and update using a large amount of data are effective, but it is difficult to collect a large amount of multimodal pair data. Therefore, the learning data is limited, and there is a possibility that the accuracy with respect to the task decreases. In addition, there is a limited case where multimodal pair data can be prepared at the time of inference, and there is a problem that inference cannot be performed in a case where there is a modal defect.

### Solution to Problem

To solve the above-described problem and achieve the object, a learning device of the present invention includes: an extraction unit configured to extract an encoding feature having a time series direction on a basis of input data of one or both of monomodal data that is data of a single modal or multimodal pair data including a plurality of different modals; an embedding unit configured to embed segment information that is information for identifying a type of the modal of the input data in the encoding feature on a basis of a predetermined condition; a connection unit configured to connect, on a basis of input condition of a segment-embedded feature in which the segment information is embedded, a plurality of segment-embedded features in the time series direction as a modal-connected feature; and a calculation unit configured to calculate a model parameter using an estimated vector of a cross-modal task estimated on a basis of one or both of the segment-embedded feature or the modal-connected feature and correct data.

### Advantageous Effects of Invention

The present invention has an effect of suppressing a decrease in accuracy in a case where a large amount of multimodal pair data cannot be prepared in estimation of a cross-modal task, and estimating a task from data of one modal in a case where there is a modal defect.

### BRIEF DESCRIPTION OF DRAWINGS

FIG. 1 is a diagram illustrating an example of an outline of a learning method by a learning device according to an embodiment.

FIG. 2 is a diagram illustrating an example of a device configuration of the learning device according to the embodiment.

FIG. 3 is a diagram illustrating an example of connection processing of segment-embedded features according to the embodiment.

FIG. 4 is a diagram illustrating an example of a modification of the learning device according to the embodiment.

FIG. 5 is a diagram illustrating an example of a flowchart of the learning method according to the embodiment.

FIG. 6 is a diagram illustrating an example of a computer on which the learning device according to the embodiment is implemented.

### DESCRIPTION OF EMBODIMENTS

Hereinafter, modes for carrying out the present embodiment (hereinafter, “embodiments”) will be described with reference to the drawings. Note that the present embodiments are not limited to the content described below.

[1. Outline of Learning Method] A learning device 100 of the present embodiment has a mechanism capable of inputting both multimodal pair data and monomodal data as learning data, learns a neural network on the basis of the learning data, and estimates the neural network as an estimated vector of a cross-modal task. Then, the learning device 100 calculates and applies parameters of the neural network to the above-described learning data. As a result, the learning device 100 estimates a task from both the multimodal pair data and the monomodal data at the time of inference.

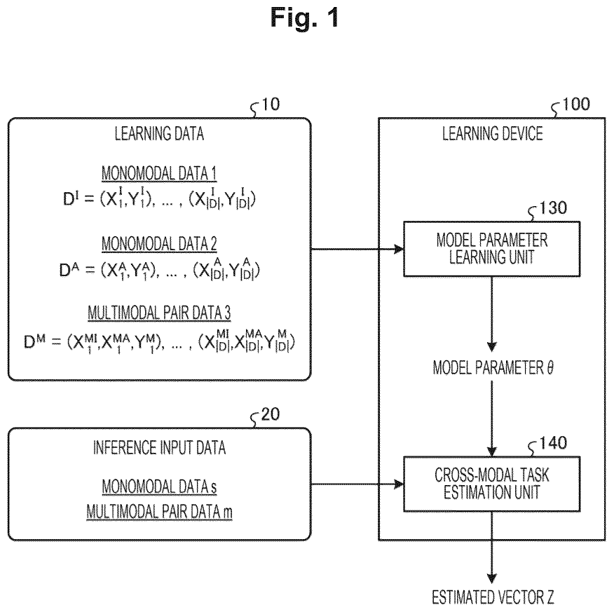

First, an example of an outline of a learning method by the learning device 100 of the present embodiment will be described with reference to FIG. 1. First, the learning device 100 acquires monomodal data 1 expression (1), monomodal data 2 expression (2), and multimodal pair data 3 expression (3) expressed by the following expressions as learning data 10. Note that, hereinafter, monomodal data 1, monomodal data 2, and multimodal pair data 3 are respectively described as “monomodal data 1 expression (1)”, “monomodal data 2 expression (2)”, and “multimodal pair data 3 expression (3)” in a unified manner. Note that the parameters included in the expressions (1) to (3) will be described in detail in the following items.

$$\begin{matrix}[ Math . 1 ] & \\ \text{?} = \text{?} , … , \text{?} & ( 1 )\end{matrix}$$

$$\begin{matrix}[ Math . 2 ] & \\ {D}^{A} = ( {X}_{1}^{A} , {Y}_{1}^{A} ) , … , ( {X}_{\vert D \vert}^{A} , {Y}_{\vert D \vert}^{A} ) & ( 2 )\end{matrix}$$

$$\begin{matrix}[ Math . 3 ] & \\ {D}^{M} = \text{?} , {X}_{1}^{MA} , {Y}_{1}^{M} ) , … , ( \text{?} , {X}_{\vert D \vert}^{MA} , {Y}_{\vert D \vert}^{M} ) & ( 3 )\end{matrix}$$

$$\text{?} \text{indicates text missing or illegible when filed}$$

Next, an extraction unit 131 of a model parameter learning unit 130 extracts and outputs an encoding feature having a time series direction on the basis of the above-described acquired learning data 10. Then, an embedding unit 132 of the model parameter learning unit 130 embeds segment information, which is information for identifying a type of a modal of the learning data, in the encoding feature on the basis of a predetermined condition, and outputs a segment-embedded feature. Next, a connection unit 133 of the model parameter learning unit 130 performs connection of the segment-embedded features in the time series direction on the basis of an input condition of the segment-embedded features and assignment of a zero-filling portion (that is zero-filling data having a mechanism for not performing learning in a calculation unit 135 to be described below, and is hereinafter simply referred to as a “zero-filling portion”), and outputs a modal-connected feature or the segment-embedded feature after the zero-filling portion assignment.

Further, an estimation unit 134 of the model parameter learning unit 130 converts the modal-connected feature or the segment-embedded feature after the zero-filling portion assignment, using a function of an arbitrary neural network, and estimates a vector corresponding to correct data Y as the estimated vector of the cross-modal task. Next, the calculation unit 135 of the model parameter learning unit 130 calculates a model parameter θ using the estimated vector of the cross-modal task.

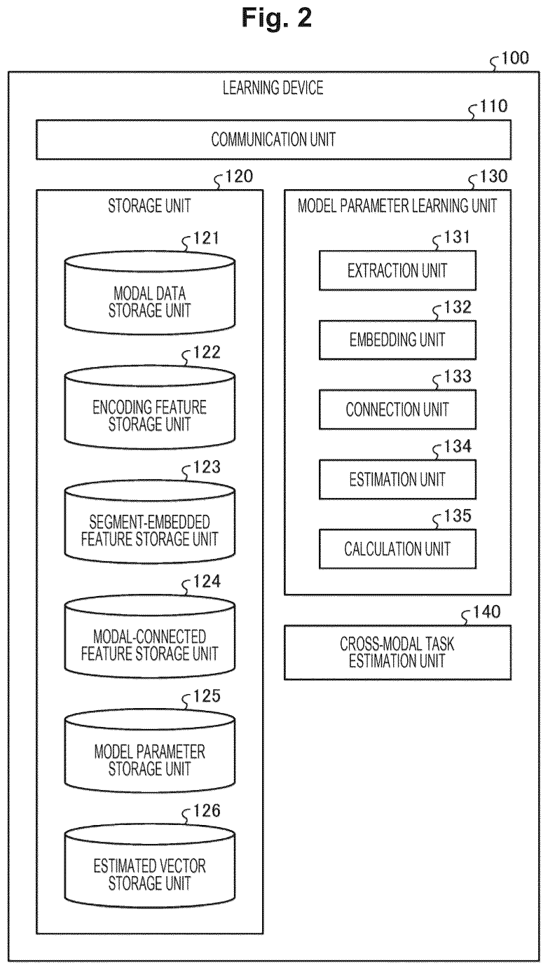

Then, a cross-modal task estimation unit 140 estimates an estimated vector Z corresponding to monomodal data s and multimodal pair data m included in inference input data 20, using the model parameter θ as an input.

[2. Configuration of Learning Device] Next, a configuration of the learning device 100 according to the present embodiment will be described with reference to FIG. 2. As illustrated in FIG. 2, the learning device 100 includes a communication unit 110, a storage unit 120, the model parameter learning unit 130, and the cross-modal task estimation unit 140. Note that, although not illustrated, the learning device 100 may include an input unit (for example, a keyboard, a mouse, and the like) that receives various operations and a display unit (for example, a display or the like) for displaying various types of information. Next, a detailed function of each unit will be described.
(Communication unit 110) The communication unit 110 is implemented by a network interface card (NIC) or the like, and controls communication via an electric communication line such as a local area network (LAN) or the Internet. Then, the communication unit 110 is connected to a network in a wired or wireless manner as necessary, and can transmit and receive information bidirectionally.
(Storage unit 120) The storage unit 120 stores data and programs necessary for various types of processing by the model parameter learning unit 130 and the cross-modal task estimation unit 140. Furthermore, the storage unit 120 includes a modal data storage unit 121, an encoding feature storage unit 122, a segment-embedded feature storage unit 123, a modal-connected feature storage unit 124, a model parameter storage unit 125, and an estimated vector storage unit 126. Then, the storage unit 120 is implemented by a semiconductor memory element such as a random access memory (RAM) or a flash memory, or a storage device such as a hard disk or an optical disk.
(Modal data storage unit 121) The modal data storage unit 121 stores the multimodal pair data and the monomodal data. For example, in an emotion recognition task, the modal data storage unit 121 stores, as the monomodal data, audio modal data in which an emotion category is labeled with respect to a voice of a person, image modal data in which an emotion category is labeled with respect to serial number image data of movement of an expression of a person, and the like. Note that information stored in the modal data storage unit 121 is not limited to the modal data and the like described above, and other modal data may be stored.
(Encoding feature storage unit 122) The encoding feature storage unit 122 stores the encoding feature having a time series direction extracted from arbitrary modal data by the extraction unit 131 to be described below,
(Segment-embedded feature storage unit 123) The segment-embedded feature storage unit 123 stores the segment-embedded feature obtained in such a manner that the embedding unit 132 to be described below embeds the segment information that is information for identifying the type of the modal of the learning data in the encoding feature.
(Modal-connected feature storage unit 124) In a case where a plurality of the segment-embedded features is input, the modal-connected feature storage unit 124 stores the modal-connected feature obtained in such a manner that the connection unit 133 connects the plurality of segment-embedded features in the time series direction, assigns the zero-filling portion, and performs the output. Further, the modal-connected feature storage unit 124 also stores the segment-embedded feature after the assignment of the zero-filling portion for which connection processing is not performed,
(Model parameter storage unit 125) The model parameter storage unit 125 stores the model parameter @ calculated by the calculation unit 135 to be described below.
(Estimated vector storage unit 126) The estimated vector storage unit 126 stores the estimated vector of the cross-modal task estimated by the estimation unit 134 to be described below and the estimated vector Z estimated by the cross-modal task estimation unit 140.
(Model parameter learning unit 130) The model parameter learning unit 130 includes the extraction unit 131, the embedding unit 132, the connection unit 133, the estimation unit 134, and the calculation unit 135. Then, the model parameter learning unit 130 includes an internal memory for temporarily storing programs and processing data defining various processing procedures and the like, and is implemented by an electronic circuit such as a central processing unit (CPU) or a micro processing unit (MPU), or an integrated circuit such as an application specific integrated circuit (ASIC) or a field programmable gate array (FPGA).
(Extraction unit 131) The extraction unit 131 extracts the encoding feature having a time series direction on the basis of input data of both or one of the monomodal data that is data of a single modal or the multimodal pair data including a plurality of different modals. Furthermore, the model parameter learning unit 130 includes a plurality of the extraction units 131 as extraction units, extracts the single encoding feature in a case where the input data is single monomodal data, and extracts the encoding feature according to the number of types of modals included in the input data in a case where the input data is one or both of two or more monomodal data or the multimodal pair data. Note that the extraction unit 131 can set an operation condition on the basis of the number, type, and the like of learning data to be input.

Furthermore, the extraction unit 131 extracts the encoding feature on the basis of an arbitrary neural network corresponding to the type of an arbitrary modal. For example, the neural network of the extraction unit 131 is configured by four convolution layers or the like developed in the time series direction in order to extract features of an image modal, and is configured by four RNN layers or the like in order to extract features of an audio modal. Note that the neural network of the extraction unit 131 is not limited to the four convolution layers or the four RNN layers described above, and other neural networks may be configured.

(Embedding unit 132) The embedding unit 132 embeds the segment information, which is information for identifying the type of the modal of the input data, in the encoding feature on the basis of a predetermined condition. Specifically, the embedding unit 132 embeds, in the encoding feature, a vector having a same sequence length as the encoding feature as an input and including a fixed value different for each modal.

The above-described segment information is a vector having an arbitrary fixed value for each modal and having the same sequence length as the encoding feature as an input (for example, when the encoding feature is an image modal, the segment information is a vector of [1, 1, 1, 1, 1, 1→the time series direction], and when the encoding feature is an audio modal, the segment information is a vector of [2, 2, 2, 2, 2, 2→the time series direction]). Then, the embedding unit 132 assigns the segment information to the encoding feature by, for example, adding the segment information to the encoding feature.

(Connection unit 133) The connection unit 133 connects a plurality of segment-embedded features in the time series direction as the modal-connected feature on the basis of the input condition of the segment-embedded features obtained by embedding the segment information in the encoding feature. Specifically, in a case of having a plurality of segment-embedded features as inputs, the connection unit 133 connects the plurality of segment-embedded features in the time series direction.

For example, having both a segment-embedded feature 1 and a segment-embedded feature 2 as inputs, the connection unit 133 connects the segment-embedded feature 1 and the segment-embedded feature 2 in the time series direction, and outputs the connected segment-embedded features as the modal-connected feature. On the other hand, in a case of having either the segment-embedded feature 1 or the segment-embedded feature 2 as an input, the segment-embedded feature 1 or the segment-embedded feature 2 after assignment of the zero-filling portion for which the connection processing is not performed is output.

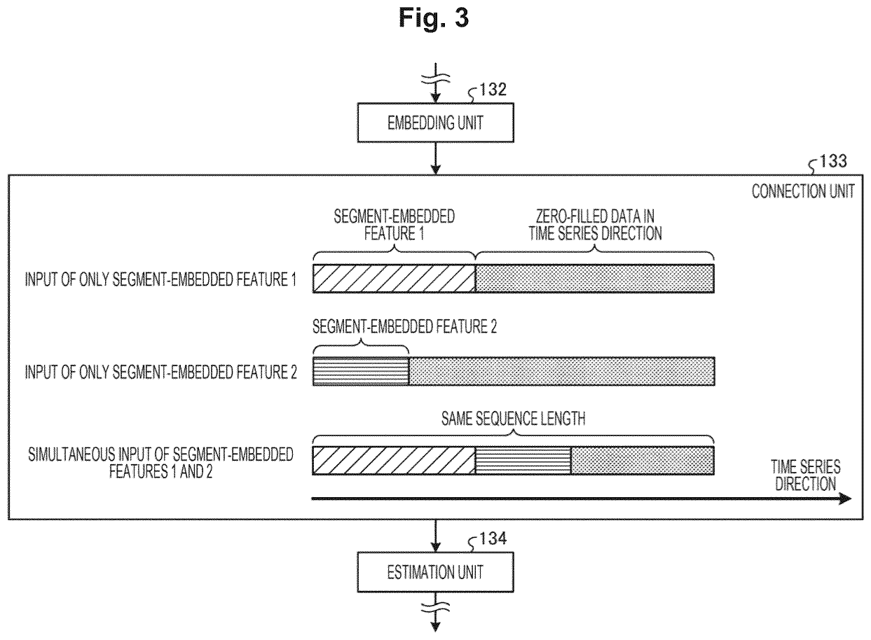

Furthermore, the connection of the segment-embedded features and the assignment of the zero-filling portion performed by the connection unit 133 will be described with reference to FIG. 3. FIG. 3 illustrates processing of the connection unit 133 in each situation of “input of only the segment-embedded feature 1”, “input of only the segment-embedded feature 2”, and “simultaneous input of the segment-embedded features 1 and 2”.

First, in the situations of the “input of only the segment-embedded feature 1” and the “input of only the segment-embedded feature 2”, the segment-embedded feature is single in both the situations. Thus, the connection unit 133 does not perform the connection processing and performs only the assignment of the zero-filling portion. Note that the connection unit 133 assigns the zero-filling portion in the time series direction such that all the segment-embedded features have the same sequence length.

Meanwhile, in the “simultaneous input of the Segment-embedded features 1 and 2”, there is a plurality of the segment-embedded features. Thus, the connection unit 133 performs the connection processing for the segment-embedded feature 1 and the segment-embedded feature 2 in the time series direction, and assigns the zero-filling portion such that all the segment-embedded features have the same sequence length.

(Estimation unit 134) Hereinafter, the description returns to FIG. 2 again. The estimation unit 134 performs conversion using a function of an arbitrary neural network on the basis of one or both of the segment-embedded feature or the modal-connected feature, and estimates the vector corresponding to the correct data Y as the estimated vector of the cross-modal task,

Furthermore, the estimation unit 134 selects the arbitrary neural network according to the type of the modal. For example, in the case of a classification task, the estimation unit 134 has four LSTM layers and two fully connected layers, and outputs a probability for each classification category. Note that the estimation unit 134 is not limited to the vectors related to the classification categories described above, and can estimate vectors related to tasks of other categories.

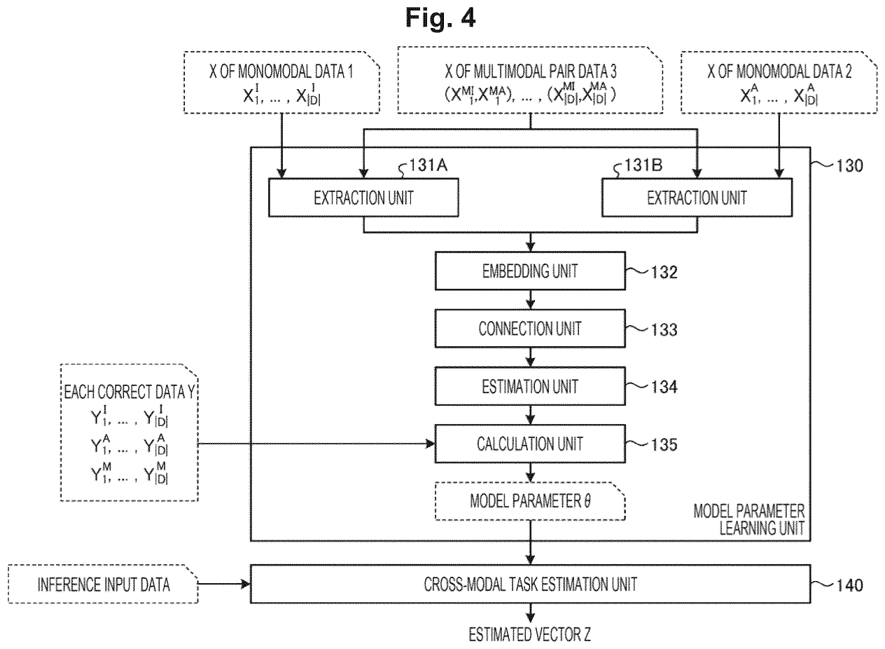

(Calculation unit 135) The calculation unit 135 iteratively performs learning using the estimated vector of the cross-modal task estimated by the estimation unit 134 on the basis of one or both of the segment-embedded feature or the modal-connected feature and the correct data Y, and calculates the model parameter θ. Specifically, the calculation unit 135 measures an error between the estimated vector of the cross-modal task and the correct data Y with respect to the model parameter θ, iteratively performs learning, and updates the model parameter θ a plurality of times to minimize the error. For example, in the case where the task is a classification task, the calculation unit 135 performs the update processing for the model parameter θ, using cross entropy or the like. Note that the calculation unit 135 is not limited to use the above-described method of updating the model parameters, and can use other methods of updating the model parameters of the neural network.
(Cross-modal task estimation unit 140) The cross-modal task estimation unit 140 estimates the estimated vector Z for the inference input data 20, using the model parameter θ calculated by the calculation unit 135 as an input. Note that the cross-modal task estimated by the cross-modal task estimation unit 140 is a “classification task that outputs the probability for each category”, a “regression task that outputs a vector”, or the like, and the cross-modal task estimation unit 140 can arbitrarily set the task.
[3. Modifications] Hereinafter, a modification of the learning method by the learning device 100 according to the present embodiment will be described with reference to FIG. 4. First, Xs included in the monomodal data 1 expression (1), the monomodal data 2 expression (2), and the multimodal pair data 3 expression (3), which are the parameters used in the present modification, will be described.

Note that, in the present modification, a case where there are two types of monomodal data and one type of multimodal pair data, that is, a case of having the monomodal data 1, the monomodal data 2, and the multimodal pair data 3 as inputs, is assumed. Note that the types of the monomodal data and the multimodal pair data are not limited to the above-described numbers, and may be other numbers.

Then, X of the above-described monomodal data is data of a single modal such as image data, audio data, text data, or the like. Meanwhile, X of the multimodal pair data is data in which two or more different modals are paired. Note that, hereinafter, for the sake of description, the monomodal data 1 is defined as “image data”, the monomodal data 2 is defined as “audio data”, and the multimodal pair data 3 is defined as “pair data of image data and audio data”. Further, Xs included in the monomodal data 1 expression (1), the monomodal data 2 expression (2), and the multimodal pair data 3 expression (3) are expressed as “X of the monomodal data 1 expression (4)”, “X of the monomodal data 2 expression (5)”, and “X of the multimodal pair data 3 expression (6)” by using the following expressions (4) to (6), and the same similarly applies hereinafter.

$$\begin{matrix}[ Math . 4 ] & \\ \text{?} , … , \text{?} & ( 4 )\end{matrix}$$

$$\begin{matrix}[ Math . 5 ] & \\ {X}_{1}^{A} , … , {X}_{\vert D \vert}^{A} & ( 5 )\end{matrix}$$

$$\begin{matrix}[ Math . 6 ] & \\ ( {X}_{1}^{Ml} , {X}_{1}^{MA} ) , … , ( {X}_{\vert D \vert}^{MI} , {X}_{\vert D \vert}^{MA} ) & ( 6 )\end{matrix}$$

$$\text{?} \text{indicates text missing or illegible when filed}$$

Note that, as the monomodal data 1 and the monomodal data 2, monomodal data extracted from the multimodal pair data 3 may be used, or data not included in the multimodal pair data 3 may be used.

First, Ys included in the monomodal data 1 expression (1), the monomodal data 2 expression (2), and the multimodal pair data 3 expression (3) will be described. Y is correct data (hereinafter, “correct data Y”) corresponding to an arbitrary task. For example, Y is a category label in the case of a classification task, or Y is a correct numerical value or a vector in the case of a regression task. Note that, in an emotion classification task, classification categories such as “happiness”, “anger”, “sorrow”, and “no emotion” are common to each data.

Note that, in the present modification, it is assumed that all the monomodal data 1 expression (1), the monomodal data 2 expression (2), and the multimodal pair data 3 expression (3) are data in the same task, and the format of the correct data Y is unified. The correct data Ys are then expressed by the following expressions (7) to (9), respectively.

$$\begin{matrix}[ Math . 7 ] & \\ \text{?} , … , \text{?} & ( 7 )\end{matrix}$$

$$\begin{matrix}[ Math . 8 ] & \\ {Y}_{1}^{A} , … , {Y}_{\vert D \vert}^{A} & ( 8 )\end{matrix}$$

$$\begin{matrix}[ Math . 9 ] & \\ {Y}_{1}^{M} , … , {Y}_{\vert D \vert}^{M} & ( 9 )\end{matrix}$$

$$\text{?} \text{indicates text missing or illegible when filed}$$

Hereinafter, each functional unit of the model parameter learning unit 130 in the present modification will be described with reference to FIG. 4. The model parameter learning unit 130 in the present modification includes a plurality of extraction units 131 including an extraction unit 131A that inputs the X of the monomodal data 1 expression (4) that is an image modal and the X of the multimodal pair data 3 expression (6), and an extraction unit 131B that inputs the X of the monomodal data 2 expression (5) that is an audio modal and the X of the multimodal pair data 3 expression (6). Note that the number of the extraction units 131 included in the model parameter learning unit 130 is not limited to the above-described two, and can be arbitrarily set according to the number of types of modals included in the monomodal data or the multimodal pair data.

Then, the extraction unit 131A extracts and outputs the encoding feature 1, and the extraction unit 131B extracts and outputs the encoding feature 2, using the above-described learning data 10 as an input. Specifically, when the following expression (10) included in the X of the monomodal data 1 expression (4) is serial number image data expression (10) of the monomodal data 1 and the following expression (11) included in the X of the multimodal pair data 3 expression (6) is serial number image data expression (11) of the multimodal pair data 3, the extraction unit 131A extracts and outputs the encoding feature 1 on the basis of the serial number image data expression (10) of the monomodal data 1 and the serial number image data expression (11) of the multimodal pair data 3. Note that, in the present modification, the extraction unit 131A can have the serial number image data expression (10) of the monomodal data 1 and the serial number image data expression (11) of the multimodal pair data 3 as input data in an arbitrary order,

$$\begin{matrix}[ Math . 10 ] & \\ \text{?} & ( 10 )\end{matrix}$$

$$\begin{matrix}[ Math . 11 ] & \\ \text{?} & ( 11 )\end{matrix}$$

$$\text{?} \text{indicates text missing or illegible when filed}$$

Meanwhile, when the following expression (12) included in the X of the monomodal data 2 expression (5) is audio data expression (12) of the monomodal data 2 and the following expression (13) included in the X of the multimodal pair data 3 expression (6) is audio data expression (13) of the multimodal pair data 3, the extraction unit 131B extracts and outputs the encoding feature 2 on the basis of the audio data expression (12) of the monomodal data 2 and the audio data expression (13) of the multimodal pair data 3. Note that, in the present modification, the extraction unit 131B can have the audio data expression (12) of the monomodal data 2 and the audio data expression (13) of the multimodal pair data 3 as input data in an arbitrary order,

$$\begin{matrix}[ Math . 12 ] & \\ {X}^{A} & ( 12 )\end{matrix}$$

$$\begin{matrix}[ Math . 13 ] & \\ {X}^{MA} & ( 13 )\end{matrix}$$

Furthermore, the extraction unit 131A and the extraction unit 131B change operation on the basis of the learning data 10 serving as input data. Specifically, in a case of having only the X of monomodal data 1 expression (4) as an input, the extraction unit 131B does not operate and only the extraction unit 131A operate, and in a case of having the X of monomodal data 1 expression (4) and the X of monomodal data 2 expression (5) as inputs, both the extraction unit 131A and the extraction unit 131B operate. Meanwhile, in a case of having the X of the multimodal pair data 3 expression (6) as an input, the extraction unit 131A and the extraction unit 131B simultaneously operate.

Next, the embedding unit 132 has both the encoding feature 1 output by the extraction unit 131A and the encoding feature 2 output by the extraction unit 131B as inputs, assigns the segment information indicating which modal feature the encoding feature is, to each of the encoding features, and outputs the segment information as the segment-embedded feature 1 and the segment-embedded feature 2.

Furthermore, the embedding unit 132 changes the operation on the basis of the encoding feature serving as input data. Specifically, in the case where the extraction unit 131A has only the expression (4) of the monomodal data 1, the embedding unit 132 outputs the segment-embedded feature 1 on the basis of the encoding feature 1 output by the extraction unit 131A. On the other hand, in the case where the extraction unit 131B has only the expression (6) of the monomodal data 2, the embedding unit 132 outputs the segment-embedded feature 2 on the basis of the encoding feature 2 output by the extraction unit 131B.

Furthermore, in the case where the extraction unit 131A and the extraction unit 131B have the serial number image data expression (11) of the multimodal pair data and the audio data expression (13) of the multimodal pair data 3 as inputs, respectively, the embedding unit 132 has both the encoding feature 1 output by the extraction unit 131A and the encoding feature 2 output by the extraction unit 131B as inputs, and outputs both the segment-embedded feature 1 and the segment-embedded feature 2.

Next, the connection unit 133 performs connection in the time series direction and assignment of the zero-filling portion for both the segment-embedded feature 1 and the segment-embedded feature 2 output by the embedding unit 132, and outputs the segment-embedded features as the modal-connected feature.

Next, the estimation unit 134 has the modal-connected feature as an input, performs conversion using the function of an arbitrary neural network, and estimates and outputs the estimated vector of the cross-modal task, which is a vector for an arbitrary task corresponding to the correct data Y.

Next, the calculation unit 135 calculates the model parameter θ, having the above-described estimated vector of the cross-modal task as an input. Note that the correct data Y used by the calculation unit 135 is the above-described expressions (7) to (9). Further, the model parameters e calculated by the calculation unit 135 may be a parameter corresponding to three of the extraction unit 131A, the extraction unit 131B, and the estimation unit 134, or may be a parameter corresponding only to the estimation unit 134.

Then, the cross-modal task estimation unit 140 estimates the estimated vector Z on the basis of the model parameter θ and the inference input data 20 described above. Note that the cross-modal task estimation unit 140 can use both the monomodal data s and the multimodal pair data m as the inference input data 20. Specifically, the above-described monomodal data s is data of data of a single modal, and is, for example, image data, audio data, text data, or the like,

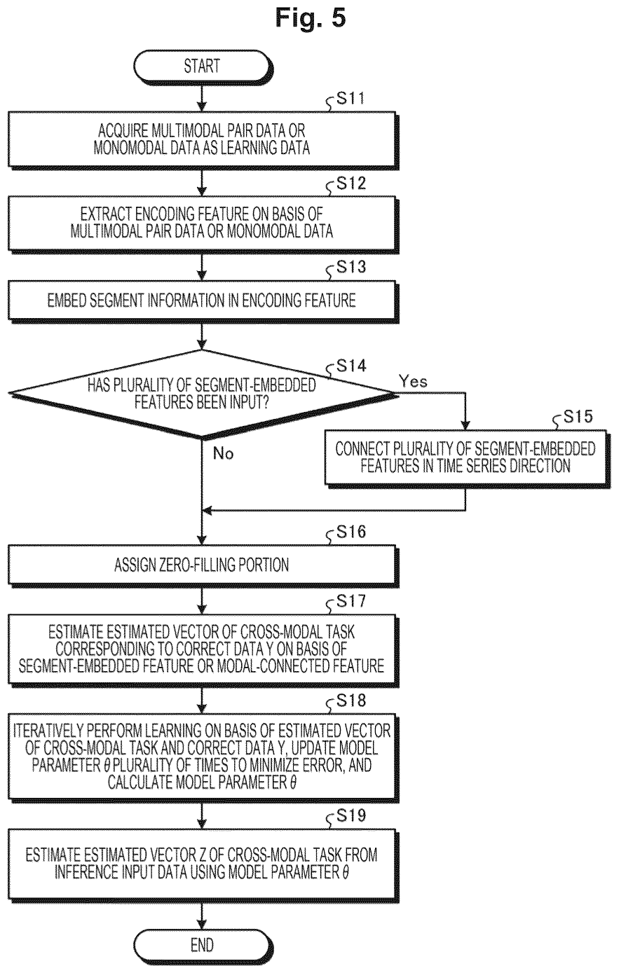

On the other hand, the multimodal pair data m is data in which two or more different modals are paired, and for example, one piece of data such as serial number image data or audio data extracted from one piece of moving image data is expressed in a plurality of different modals.

[4. Processing Procedure] Next, a procedure of the learning method by the learning device 100 will be described with reference to FIG. 5. First, the model parameter learning unit 130 acquires the multimodal pair data or the monomodal data as learning data (process S11). Next, the extraction unit 131 extracts the encoding feature on the basis of the multimodal pair data or the monomodal data (process S12). Next, the embedding unit 132 embeds the segment information in the encoding feature (process S13).

Next, the connection unit 133 determines that a plurality of segment-embedded features is input (Yes in process S14). In this case, the connection unit 133 connects the plurality of segment-embedded features in the time series direction (process S15). On the other hand, when determining that the plurality of segment-embedded features is not input, the connection unit 133 proceeds to the next process without performing the connection processing (No in process S14). Next, the connection unit 133 assigns the zero-filling portion to the single segment-embedded feature or the modal-connected feature obtained by connecting the plurality of segment-embedded features (process S16).

Next, the estimation unit 134 estimates the estimated vector of the cross-modal task for an arbitrary task corresponding to the correct data Y on the basis of the segment-embedded feature or the modal-connected feature (process S17). Next, the calculation unit 135 iteratively performs learning on the basis of the estimated vector of the cross-modal task and the correct data Y, updates the model parameter θ a plurality of times to minimize the error, and calculates the model parameter θ (process S18). Then, the cross-modal task estimation unit 140 estimates the estimated vector Z of the cross-modal task from the inference input data, using the model parameter θ (process S19).

[5. Effects] As described above, the learning device 100 extracts the encoding feature having the time series direction on the basis of the input data of one or both of the monomodal data that is data of a single modal or the multimodal pair data including a plurality of different modals, embeds the segment information that is information for identifying the type of the modal of the input data in the encoding feature on the basis of a predetermined condition, connects a plurality of segment-embedded features in the time series direction as the modal-connected feature on the basis of the input condition of the segment-embedded feature in which the segment information is embedded, and calculates the model parameter using the estimated vector of the cross-modal task estimated on the basis of one or both of the segment-embedded feature or the modal-connected feature and the correct data. Therefore, according to the present embodiment, the following effects are obtained.

The learning device 100 provides an effect of enabling highly accurate estimation of the cross-modal task optimized by both the multimodal pair data and the monomodal data.

Furthermore, the learning device 100 operates regardless of which of the multimodal pair data or the monomodal data is input, and provides the effect of enabling estimation of the cross-modal task,

Then, the learning device 100 provides an effect of suppressing a decrease in accuracy with respect to the task in a case where only limited data can be prepared.

[6. Hardware Configuration] Each component of each device illustrated in the drawings is functionally conceptual and does not necessarily need to be physically configured as illustrated. That is, specific forms of distribution and integration of devices are not limited to the illustrated forms, and some or all of the devices can be functionally or physically distributed and integrated in any units according to various loads, usage conditions, and the like. Furthermore, all or an arbitrary part of each processing function performed in each device can be implemented by a CPU and a program analyzed and executed by the CPU, or can be implemented as hardware by wired logic.

Moreover, among the pieces of processing described in the present embodiment, all or part of the processing described as being automatically performed can be manually performed by a known method, Processing procedures, control procedures, specific names, and information including various types of data and parameters described in the drawings can be arbitrarily changed unless otherwise mentioned,

[Program] As an embodiment, the learning device 100 can be implemented by installing a learning program for executing the above learning as packaged software or online software in a desired computer. For example, an information processing device can be caused to function as the learning device 100 by causing the information processing device to execute the above learning program. The information processing device mentioned here includes a desktop or a laptop personal computer. In addition, the information processing device also includes a mobile communication terminal such as a smartphone, a mobile phone, and a personal handyphone system (PHS), a slate terminal such as a personal digital assistant (PDA), and the like.

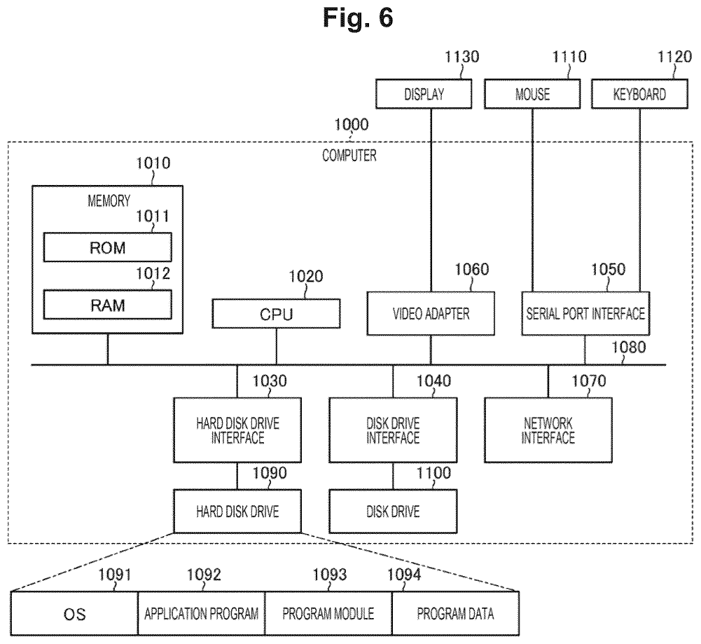

FIG. 6 is a diagram illustrating an example of a computer on which the learning device 100 is implemented. A computer 1000 includes, for example, a memory 1010 and a CPU 1020. Furthermore, the computer 1000 also includes a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, the program that defines each processing operation of the learning device 100 is implemented as the program module 1093 in which codes executable by a computer are described. The program module 1093 is stored in, for example, the hard disk drive 1090. For example, the program module 1093 for executing processing similar to that of the functional configuration in the learning device 100 is stored in the hard disk drive 1090. Note that the hard disk drive 1090 may be replaced with a solid state drive (SSD),

In addition, setting data used in the processing in the embodiment described above is stored in, for example, the memory 1010 or the hard disk drive 1090 as the program data 1094. Then, the CPU 1020 reads the program module 1093 and the program data 1094 stored in the memory 1010 or the hard disk drive 1090 to the RAM 1012 as necessary and executes the processing in the embodiment described above.

The program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (LAN, wide area network (WAN), or the like). Then, the program module 1093 and the program data 1094 may be read by the CPU 1020 from another computer via the network interface 1070.

[7. Others] Although the present embodiment has been described above, the present embodiment is not limited by the description and drawings constituting a part of the disclosure. In other words, other embodiments, examples, operation technologies, and the like made by those skilled in the art and the like based on the present embodiment are all included in the scope of the present embodiment.

### REFERENCE SIGNS LIST

10 Learning data
20 Inference input data
100 Learning device
110 Communication unit
120 Storage unit
121 Modal data storage unit
122 Encoding feature storage unit
123 Segment-embedded feature storage unit
124 Modal-connected feature storage unit
125 Model parameter storage unit
126 Estimated vector storage unit
130 Model parameter learning unit
131 Extraction unit
131A Extraction unit
131B Extraction unit
132 Embedding unit
133 Connection unit
134 Estimation unit
135 Calculation unit
140 Cross-modal task estimation unit
1000 Computer
1010 Memory
1011 ROM
1012 RAM
1020 CPU
1030 Hard disk drive interface
1040 Disk drive interface
1050 Serial port interface
1060 Video adapter
1070 Network interface
1080 Bus
1090 Hard disk drive
1091 OS
1092 Application program
1093 Program module
1094 Program data
1100 Disk drive
1110 Mouse
1120 Keyboard

1. A learning device comprising:
processing circuitry configured to:
extract an encoding feature having a time series direction on a basis of input data of one or both of monomodal data that is data of a single modal or multimodal pair data including a plurality of different modals;
embed segment information that is information for identifying a type of the modal of the input data in the encoding feature on a basis of a predetermined condition;
connect, on a basis of input condition of a segment-embedded feature in which the segment information is embedded, a plurality of segment-embedded features in the time series direction as a modal-connected feature; and
calculate a model parameter using an estimated vector of a cross-modal task estimated on a basis of one or both of the segment-embedded feature or the modal-connected feature and correct data.

2. The learning device according to claim 1, wherein the processing circuitry is further configured to:
extract the single encoding feature in a case where the input data is the single monomodal data, and
extract the encoding feature according to a number of types of the modals included in the input data in a case where the input data is one or both of two or more of the monomodal data or the multimodal pair data.

3. The learning device according to claim 2, wherein the processing circuitry is further configured to
extract the encoding feature on a basis of a neural network corresponding to the type of the modal.

4. The learning device according to claim 1, wherein the processing circuitry is further configured to
embed, in the encoding feature, a vector having a same sequence length as the encoding feature as an input and including a fixed value different for each modal.

5. The learning device according to claim 1, wherein the processing circuitry is further configured to
in a case of having a plurality of the segment-embedded features as inputs, connect the plurality of the segment-embedded features in the time series direction.

6. The learning device according to claim 1, wherein the processing circuitry is further configured to
perform conversion using a function of an arbitrary neural network on a basis of one or both of the segment-embedded feature or the modal-connected feature, and estimate a vector corresponding to the correct data as the estimated vector of the cross-modal task.

7. A learning method comprising:
extracting an encoding feature having a time series direction on a basis of input data of one or both of monomodal data that is data of a single modal or multimodal pair data including a plurality of different modals;
embedding segment information that is information for identifying a type of the modal of the input data in the encoding feature on a basis of a predetermined condition;
connecting, on a basis of input condition of a segment-embedded feature in which the segment information is embedded, a plurality of segment-embedded features in the time series direction as a modal-connected feature; and
calculating a model parameter using an estimated vector of a cross-modal task estimated on a basis of one or both of the segment-embedded feature or the modal-connected feature and correct data, by processing circuitry.

8. A non-transitory computer-readable recording medium storing therein a learning program that causes a computer to execute a process comprising:
extracting an encoding feature having a time series direction on a basis of input data of one or both of monomodal data that is data of a single modal or multimodal pair data including a plurality of different modals;
embedding segment information that is information for identifying a type of the modal of the input data in the encoding feature on a basis of a predetermined condition;
connecting, on a basis of input condition of a segment-embedded feature in which the segment information is embedded, a plurality of segment-embedded features in the time series direction as a modal-connected feature; and
calculating a model parameter using an estimated vector of a cross-modal task estimated on a basis of one or both of the segment-embedded feature or the modal-connected feature and correct data.
